(19) United States
(12) Patent Application Publication
(10) Pub. No.: US 2011/0307333 A1
(43) Pub. Date: Dec. 15, 2011

(54) WEB CLIENT, SYSTEM FOR PROVIDING WEB CLIENT, DATA PROCESSING DEVICE, AND SYSTEM AND METHOD FOR PROVIDING DATA PROCESSING DEVICE

(76) Inventor: Boo-Joong JANG, Seoul (KR)

(21) Appl. No.: 13/155,828

(22) Filed: Jun. 8, 2011

(30) Foreign Application Priority Data
Jun. 9, 2010 (KR) 10-2010-0054288

(51) Int. Cl. G06F 3/01; G06Q 30/00; G06F 17/30

(52) U.S. Cl. 705/14.49; 715/760; 707/769; 707/E17.014

(57) ABSTRACT

A web client, a system for providing a web client, a data processing device, and a system and method for providing a data processing device. The web client is set to a text non-input status. When a keyword is input to a data processing device, which operates the web client, by an input device in the text non-input status, the system for providing a web client uses the keyword for a predetermined purpose or determines the purpose of the keyword from among a plurality of purposes.

### CROSS REFERENCE TO RELATED APPLICATIONS

This application claims priority to Korean Patent Application No. 10-2010-0054288, filed on Jun. 9, 2010, under 35 U.S.C. §119 the disclosure of which is incorporated herein in its entirety by reference.

### BACKGROUND OF THE INVENTION

1. Field of the Invention

The present invention relates to a web client, a system for providing a web client, a data processing device, and a system and method for providing a data processing device, and more particularly, to a web client or a data processing device that can receive text input even if the text is not input into a particular area, and that can perform certain functions using the input text, and a system and method for providing the web client or the data processing device.

2. Description of the Related Art

Driven by the development of internet or wireless communication techniques, numerous information and content are used and distributed on the internet.

Users utilize web clients like web browser etc in order to use these numerous information or content. Users sometimes enter predetermined text while using web client. For instance, a user may put in a URL (Uniform Resource Locator) in order to designate the web page that he/she intends to browse, type in a search term to use predetermined search service, or put in character to enter various information like log-in information and payment information etc that the web page requests.

In general, users input a URL or search term once or multiple times to obtain information or content they want. For instance, if a user wants to move from a web page to another, he/she not only can select a link from the presently browsed webpage, but also can put a URL that he/she wants into a URL input UI (User Interface). At this time the user must place a cursor to the URL space. First, the user generally places a cursor to the URL input window with the mouse, and inputs URL through a keyboard again. Therefore, this method involves the inconveniences of using two types of input devices (e.g. a mouse or keyboard) to input URL, and placing a cursor to the already set location by selecting certain location or UI.

Such inconvenience is further aggravated when search term is used. The user can use various search services to search information that he/she wants. The search service can be provided in diverse forms such as search site, web page that provides search option, or add-on application that provides a search tool on a web browser. The user must perform common work to use these search services provided in various forms. In other words, the user can input search terms only when cursor is placed at the search UI called as search window using a pointer (e.g. a mouse pointer). If the user performed scroll to search information, then the search UI might not exist in the present screen. Therefore, there are many cases that a user has to scroll to find this search UI.

After all if users are required to repeat action of placing a cursor to a certain location in order to input a keyword (e.g. a text) as using the web client, then it slows down the work process and repeats simple behavior. And such problem can deteriorate as the user uses web client more frequently or for longer time.

Therefore, there are impending needs for method and system that enables users to put in texts and make web client even more effective and convenient to use even when a cursor is not placed at a UI while web client or certain data processing device (e.g. a user computer) are used.

The information disclosed in this Background of the Invention section is only for the enhancement of understanding of the background of the invention, and should not be taken as an acknowledgment or any form of suggestion that this information forms a prior art that would already be known to a person skilled in the art.

### BRIEF SUMMARY OF THE INVENTION

Therefore, the technical task of the present invention is to provide method and system that can perform predetermined functions by using the input text (e.g. the keyword) even though text is put in when certain condition for text inputting is not satisfied while a web client or a data processing device are used. In addition, the technical task also includes method and system to use the input text differently according to pointer status or characteristics of the browsing web page.

Another task is to provide method and system that can transmit advertisement content that correspond to relevant keyword to the user or the keyword's destination system for each use by processing the input text or keywords that are put in when a particular condition for text input is not satisfied as a significant keyword that expresses user's interests.

An embodiment of the present invention provides method for providing a web client, the method comprising, the web client being set as a text non-input status, a system for providing a web client determining a keyword as one purpose among multiple predetermined purposes or using the keyword as predetermined purpose, when the keyword is input by an input device at the text non-input status.

An embodiment of the present invention provides method for providing a web client, the method comprising, the web client being set as a text non-input status, being input a keyword by input device at the text non-input status, and displaying search result corresponding to the keyword as the search term by the web client.

An embodiment of the present invention provides method for providing a web client, the method comprising, the web client being set as a text non-input status, being input a keyword by input device at the text non-input status, and browsing URL corresponding to the keyword by the web client.

An embodiment of the present invention provides method for providing a web client, the method comprising, the web client being set as a text non-input status, when a keyword is input by an input device at the text non-input status, transmitting the keyword to advertising server and receiving an advertising content transmitted from the advertising server in response to the transmitting.

An embodiment of the present invention provides method for providing a web client, the method comprising, the web client being set as a text non-input status, when a keyword is input by an input device at the text non-input status, determining the keyword as one purpose among multiple predetermined purposes or using the keyword as predetermined purpose, and controlling advertising server to transmit an advertising content to a target system corresponding to use results when the keyword is used according to the determined purpose, wherein the advertising content is selected by the advertising server based on the keyword.

An embodiment of the present invention provides method for providing a data processing device, the method comprising, the data processing device being set as a text non-input status, determining a keyword as one purpose among multiple predetermined purposes or using the keyword as predetermined purpose, when the keyword is input by an input device at the text non-input status.

An embodiment of the present invention provides method for providing a data processing device, the method comprising, the data processing device being set as a text non-input status, when a keyword is input by an input device at the text non-input status, transmitting the keyword to advertising server and receiving an advertising content transmitted from the advertising server in response to the transmitting.

An embodiment of the present invention provides method for providing a data processing device, the method comprising, the data processing device being set as a text non-input status, when a keyword is input by an input device at the text non-input status, determining the keyword as one purpose among multiple predetermined purposes or using the keyword as predetermined purpose, and controlling advertising server to transmit an advertising content to a target system corresponding to use results when the keyword is used according to the determined purpose, wherein the advertising content is selected by the advertising server based on the keyword.

An embodiment of the present invention provides system for providing a web client linked to a web client that can browse a web page, wherein the system for providing a web client is configured to determine a keyword as one purpose among multiple predetermined purposes or use the keyword as predetermined purpose, when the web client is set as a text non-input status and the keyword is input by an input device at the text non-input status.

An embodiment of the present invention provides system for providing a web client linked to a web client that can browse a web page, wherein the system for providing a web client is configured to control the web client to displays search result corresponding to a keyword as a search term, when the keyword is input by an input device while the web client being set as a text non-input status.

An embodiment of the present invention provides system for providing a web client linked to a web client that can browse a web page, wherein the system for providing a web client is configured to control the web client to browse URL corresponding to a keyword, when the keyword is input by an input device while the web client being set as a text non-input status.

An embodiment of the present invention provides web client that can browse a web page, wherein the web client displays search result corresponding to a keyword as a search term, when the keyword is input by an input device while the web client being set as a text non-input status.

An embodiment of the present invention provides web client that can browse a web page, wherein the web client browse URL corresponding to a keyword, when the keyword is input by an input device while the web client being set as a text non-input status.

An embodiment of the present invention provides A system for providing a data processing device comprising, a reception module receiving a keyword input by an input device while data processing device being set as a text non-input status, and a control module determining the keyword as one purpose among multiple predetermined purposes or using the keyword as predetermined purpose.

An embodiment of the present invention provides system for providing a web client, the system comprising, a reception module receiving a keyword input by an input device while a web client being set as a text non-input status, and an advertising module transmitting the received keyword to advertising server and receiving an advertising content transmitted from the advertising server in response to the transmitting.

An embodiment of the present invention provides system for providing a web client, the system comprising, a reception module receiving a keyword when the keyword is input by an input device while a web client being set as a text non-input status, a control module determining the keyword received from the reception module as one purpose among multiple predetermined purposes or using the keyword as predetermined purpose, and an advertising module controlling an advertising server to transmit an advertising content to a target system corresponding to use results when the keyword is used according to the determined purpose, wherein the advertising content is selected by the advertising server based on the keyword.

An embodiment of the present invention provides system for providing a data processing device, the system comprising, a reception module receiving a keyword input by an input device while a data processing device being set as a text non-input status, and an advertising module transmitting the received keyword to advertising server and receiving an advertising content transmitted from the advertising server in response to the transmitting.

An embodiment of the present invention provides system for providing a data processing device, the system comprising, a reception module receiving a keyword when the keyword is input by an input device while a data processing device being set as a text non-input status, a control module determining the keyword received from the reception module as one purpose among multiple predetermined purposes or using the keyword as predetermined purpose, and an advertising module controlling an advertising server to transmit an advertising content to a target system corresponding to use results when the keyword is used according to the determined purpose, wherein the advertising content is selected by the advertising server based on the keyword.

According to exemplary embodiments of the invention, the web client, and the system for providing a web client, the data processing device, and the system and method for providing them according to the technical idea of the present invention facilitate such effect that particular functions like inputting of URL, inputting of search term, inputting of comments and transmitting of message or e-mail etc can be performed even if there has not been done any configuring of text input status performed in simple repetition, that is, any serial actions of putting cursor to text input UI by selecting (e.g. clicking) predetermined button after grabbing the mouse with hand and moving the cursor to the text input UI for the web client or data processing device.

In particular, the present invention increases user convenience and reduce inconvenience by the following features:
The system does not require the user to move hand location in order to use various input devices alternately in case configuring of text input mode requires use of various different input devices like keyboard etc that puts in texts or mouse etc;
The system does not require user to load user interface that provides particular function or to move to such user interface;
Web client or data processing device automatically judges which function to execute with the entered text (keyword) and execute applicable function selectively in case multiple functions are executed through text input;
The system executes particular function even on webpage that does not include particular function like search service etc;

Moreover, the proposed system can transmit the advertisement content that correspond to entered text or keyword by processing the entered text or keyword as significant keyword that expresses user's interest in case particular condition for text input is not satisfied.

### BRIEF DESCRIPTION OF THE DRAWINGS

The accompanying drawings are intended to depict example embodiments of the present invention and should not be interpreted to limit the scope thereof. The accompanying drawings are not to be considered as drawn to scale unless explicitly noted.

FIG. 1 and FIG. 2 illustrate a method for providing a web client according to an exemplary embodiment of the present invention.

FIG. 3 illustrates the method for providing the web client according to an exemplary embodiment of the present invention.

FIG. 4 illustrates the use of keyword by characteristics of web page in providing the web client according to an exemplary embodiment of the present invention.

FIG. 5 illustrates the use of keyword according to status of pointer in providing the web client according to an exemplary embodiment of the present invention.

FIG. 6 illustrates the case where the keyword entered in text non-input status is processed as the input value of particular text input UI in providing web client according to an exemplary embodiment of the present invention.

FIG. 7 illustrates the concept of processing the entered keyword in text non-input status in providing web client according to an exemplary embodiment of the present invention.

FIG. 8 illustrates the flow of processing the entered keyword in text non-input status in providing web client according to an exemplary embodiment of the present invention.

FIG. 9 illustrates the flow of providing web client or data processing device according to an exemplary embodiment of the present invention.

FIG. 10 illustrates the composition of a system where a keyword is used as search keyword by web client according to an exemplary embodiment of the present invention.

FIG. 11 illustrates the method of keyword advertisement using web client or data processing device according to an exemplary embodiment of the present invention.

### DETAILED DESCRIPTION OF THE INVENTION

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

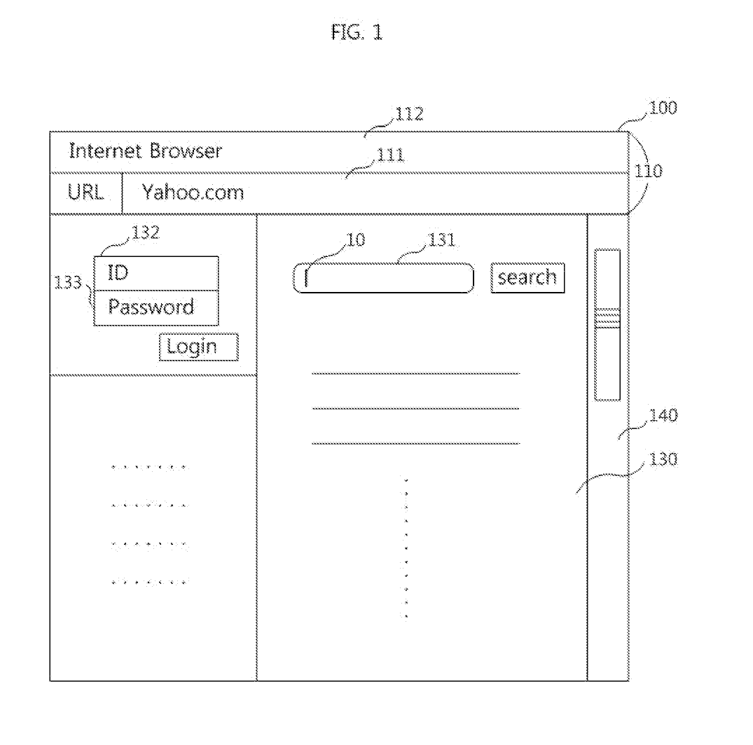

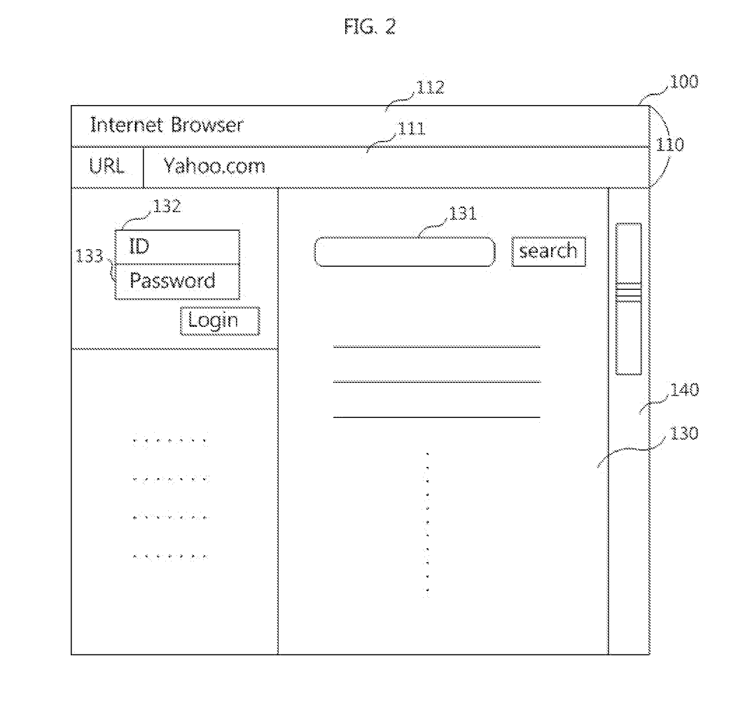

FIG. 1 and FIG. 2 illustrate a method for providing a web client according to an exemplary embodiment of the present invention.

In FIG. 1 and FIG. 2, a web client (e.g. a web browser) 100 can display the screen as in FIG. 1 when the web client 100 is browsing predetermined web page.

The web client 100 can include predetermined interface (e.g. 110, 140, and etc.) that the web client itself includes. For example, interfaces 110 and 140 can have a title interface 112 that displays the title of the browsing web page, a URL interface 111 that can input the address (e.g. URL), and/or a scroll interface 140 that can scroll the web page. The interfaces 110 and 140 can include text input UI that can put in text as URL interface 111. In this Specification, text indicates meanings including number and special mark. Moreover, the text input UI can be used as the meaning that includes various interfaces that can put in text (e.g. text box, board UI, comment UI, and etc.). It is not shown on the FIG. 1, but if predetermined add-on applications (e.g. a predetermined tool bar) are installed at the web client 100 then text input UI that can input text can be included.

The web page (e.g. “yahoo.com”) that the web client 100 is browsing can include predetermined text input UI (e.g. 131, 132, 133, and etc.) that can input text. For example, as shown on the FIG. 1, if the web page (e.g. “yahoo.com”) offers log-in function then the web page (e.g. “yahoo.com”) can include ID input UI 131 and password input UI 133 as the text input UI. If the web page (e.g. “yahoo.com”) provides search service then search text input UI 131 that can input search terms, in other words the search window 131 can be included in the web page (e.g. “yahoo.com”).

A user wants to browse other web page as using the browsed web page (e.g. “yahoo.com”) at the web client 100. At this time, predetermined link (e.g. hyper link, embedded link) included in the web page (e.g. “yahoo.com”) can be selected, or a cursor 10 can be placed at the URL interface 111 after moving the pointer to the URL interface 111. And when inputting text after that, the text is put into the URL interface 111.

When user want to input text into the ID input UI 132 and/or password input UI 133, user also move pointer to the relevant UI, perform predetermined action (e.g. clicking), place a cursor 10 to the relevant UI, and input ID and/or password.

When a user wants to use search function, the user can move the pointer to search window 131 and input search term after placing a cursor 10 to the search window 131.

In any cases text input UI should exist when a user wants to input text as using the web client 100, and there is a condition that a cursor must be located at the text input UI. This specification defines this status where this condition is satisfied as text input status. After all, only the text (e.g., the keyword) entered after it becomes text input status can be used significantly for driving the web client 100.

When text input UI does not exist at the web client 100 or at the web page browsed by the web client 100, or even when text input UI exists if a cursor 10 is not located at the text input UI, then the web client 100 ignores the entered text or keyword. This specification defines this case where the entered text or keyword is ignored by the web client 100 or the entered text or keyword does not have effect on the web client 100 even through text or keyword is entered through an input device (e.g. a keyboard) as text non-input status.

Text non-input status according to exemplary embodiment of the present invention can be a condition where a cursor is not located both a first text input UI and a second text input UI. The first text input UI may be a text input UI that web client itself provides (e.g. the URL interface 111 or a text input UI that a tool bar installed at the web client 100 provides). The second text input UI (e.g. 131, 132, 133, and etc.) may be text input UI included in the page (e.g. default page or predetermined web page (e.g. “yahoo.com”) that displayed by the web client 100.

Also, it can be text non-input status when text input UI does not exist at anywhere in the web client 100 itself or the page displayed by the web client 100. Or when text input UI does not exist in the page displayed by the web client 100 and a cursor is not located at the first text input UI provided by the web client 100.

While a user uses the web client 100, the web client 100 can be changed from text input status to text non-input status or vice versa. For example, it can be text input status when a cursor exists at the search window 131. When a user selects a predetermined key (e.g. a tab) or selects (e.g. clicks) other predetermined territory other than the first text input UI (e.g. 111) and the second text input UI (e.g. 131, 132, 133, and etc.) with a control device (e.g. a touch pad or a mouse), the web client 100 can be set as text non-input status. For example, it can be text non-input status condition as shown in FIG. 2 when a user selects predetermined object from the territory 130 that displays the web page (e.g. “yahoo.com”), or an empty territory where no information is displayed, or selects territory (e.g. 112, 140) that is not text input UI among interfaces that is provided by the web client 100. Of course, predetermined action for locating a cursor 10 to text input UI on text non-input status can make the web client 100 as text input status again.

Like this, users often use the web client 100 as text non-input status while using the web client 100 by scrolling or using control device (e.g. touch pad, mouse, and etc.).

For example, user may input predetermined keyword in the search window 131, checks the search result, and selects predetermined link or predetermined object by scrolling or using control device. Then, the web client 100 can be text non-input status. The user can input search term again and perform new search at this status. To that end, a user must perform text input action after performing act of scrolling, controlling pointer, and/or selecting (e.g. clicking) to locate a cursor to the search window 131. Or the user can input URL into the URL interface 111 in order to browse other web page at text non-input status. At this time, prescribing action of locating a cursor at the URL interface 111 must be performed.

Generally, when a user performs internet surfing or information search by using the web client 100, the user performs many actions as above-mentioned to transform from text non-input status to text input status. However, this can be very inefficient. Therefore, when a predetermined keyword (e.g. a text) is entered at text non-input status, a user can easily perform wanted function (e.g. browsing function of other web page or search service function, message sending function, email sending function, or comment writing function) without performing transformation from text non-input status to text input status, through if the client 100 uses the keyword as an input parameter or input value to perform a certain function without ignoring the entered keyword like as prior art web client. For example, if predetermined keyword is entered at text non-input status then the keyword is set as the input parameter of a certain text input UI (e.g. a URL interface 111 or a search window 131) or the keyword can be transmitted to predetermined system (e.g. a search server). If predetermined keyword is entered at text non-input status then the keyword can be processed as the input parameter of a certain text input UI (e.g. a UI for commenting or community board) that is included or displayed by the web client 100. Or the keyword can be processed as the input parameter of some application, not the web client 100.

For instance, if predetermined keyword is entered at text non-input status then the keyword can be transmitted with email client. The email client can use the keyword as one piece of content of an email, title, or email address. Other required information (e.g. a title and an email address when the keyword is used as the content of the email) can be entered by user additionally. According to one exemplary embodiment of invention, some of information (e.g. email address) that the email client requires to send email can be set already. For example, when the keyword is used as the content of the email, the email client can send email that makes the keyword as the content of the email with predetermined email address. Or the user can select one of email addresses registered already, and then the email, which has the keyword as the content with selected email address, can be transmitted.

In addition, if predetermined keyword is entered at text non-input status then the keyword can be transmitted to message transfer client. The message transfer client can mean an application that can send a message (e.g. an SMS (short messaging service) message or a MMS (multimedia messaging service) message) to a certain phone number. Then the message transfer client can use the transmitted keyword as the content of the message. The message transfer client can transmit message to predetermined phone number that has the keyword as the content. A user can input a certain phone number and a message that has the keyword as the content with the entered phone number according to one exemplary embodiment of the invention.

The web client, the system for providing a web client, the data processing device, and the system and method for providing the same according to exemplary embodiment of the invention can provide this technical idea.

In addition, technical idea as mentioned-above is not only embodied by the web client 100 or the system for providing a web client 100, but also it can be embodied by predetermined data processing device (not shown, for example, user computer and mobile terminal) or the system for providing the data processing device. In other words, the data processing device also has text input status and text non-input status. If some text is entered when the data processing device is set as text non-input status, then it means case of not the data processing device display the entered text, or it means case of not entered text is used as some input parameter even though the entered text is not displayed. In other words, some data processing device is set as text non-input status, it may mean that OS of data processing device ignores the entered text. Namely, a state where OS installed at the data processing device ignores and does not react even through text or keyword is put into the keyboard UI provided by touch screen or some input device (e.g. keyboard) can be defined as text non-input status. On the contrary to this, the status when text can be entered to UI provided by the data processing device or through an application run by the data processing device can be defined as text input status. If predetermined keyword is entered when predetermined data processing device is at text non-input status according to technical idea of the present invention, then the data processing device can process the keyword as parameter (input value) to perform a certain function by an application (e.g. web client, instant messaging client, email client, or message transfer client).

For example, a user may input predetermined keyword when the data processing device is set as text non-input status. Then the data processing device can display the search results on to a predetermined application (e.g., a web client) corresponding to the keyword as the search term by transmitting the keyword to predetermined search server. Or a web page having URL corresponding to the keyword can be browsed, URL corresponding to the keyword can be searched at predetermined list or DB, and then a web page corresponding to the searched URL can be browsed.

If predetermined keyword is entered to the data processing device at text non-input status as mentioned-above, then the keyword can be used as a certain input parameter of a certain application (e.g. a message transfer client or an email client).

From now on, description of the present invention usually explains the case where predetermined keyword is entered at the web client at text non-input status after predetermined web client is activated, but predetermined normal expert in technical field of the present invention can easily draw inference that these technical ideas can be applied to a predetermined data processing device.

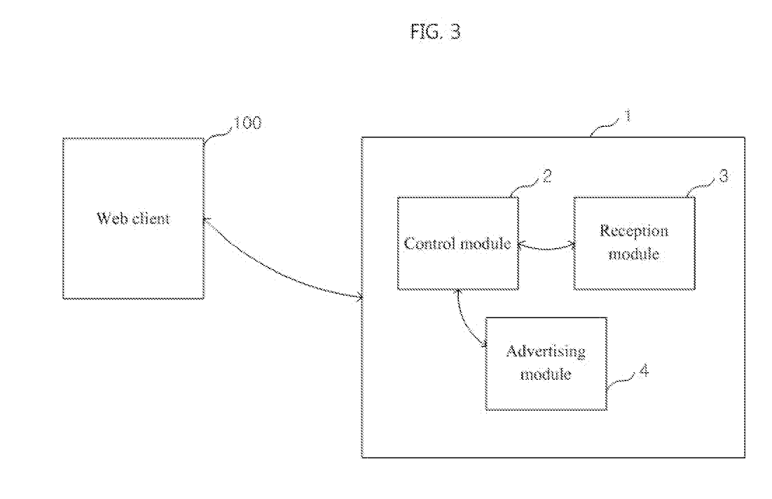

FIG. 3 illustrates schematic structure of system for providing a web client according to an embodiment of the present invention.

As shown in FIG. 3, system for providing a web client 1 according to an embodiment of the present invention may include a control module 2 and a reception module 3. system for providing a web client 1 may further include advertisement module 4 according to an embodiment of the present invention. The system for providing a web client 1 may include the reception module 3 and the advertisement module 4 according to an embodiment of the present invention. Functions and behaviors of the advertisement module 4 will be described later.

In addition, a system for providing a data processing device can be embodied corresponding to the system for providing a web client 1 as mentioned-above. In other words, the system for providing a data processing device also can include a control module and a reception module. The system for providing a data processing device may further include advertisement module according to an exemplary embodiment of present invention. The system for providing a data processing device may include the reception module and the advertisement module according to example of implementation. Each module included in the system for providing a data processing device corresponds with each module included in the system for providing a web client 1, and it can perform similar functions.

The system for providing a web client 1 can be installed as an add-on software or plug-in program at the web client 100, or it can be embodied in predetermined script form as being included in the web client 100 to embody technical idea of present invention. In other words, system for providing a web client 1 does not need to be embodied as a distinct application or program code from the web client 100. Of course, it can be embodied as distinct application from the web client 100 so sending and receiving predetermined information with the web client 100 to embody present invention. The system for providing a data processing device also can be installed at the data processing device, and it can be embodied in a form of predetermined application. From here, the system for providing a web client 1 will be explained.

Each component of the system for providing a web client 1 is separately indicated on drawings to show it can be separated functionally and logically, and it doesn't mean it is separated (distinct) component physically or it is realized as separated (distinct) code.

A module in this specification can mean functional and structural combination of software to run hardware to perform technical idea of the present invention and the hardware. For example, the module can mean a logical unit of hardware recourse to perform predetermined code predetermined code, and the fact that it does not always mean a code physically connected or one kind of hardware can be easily deducted by normal experts in this technical field of the present invention.

For instance, a control module 2 of the system for providing a web client 1 is installed by being included in the web client 100, and the reception module 3 can be realized as distinct application from the web client 100.

The reception module 3 can receive the keyword entered from the web client 100 at text non-input status.

The reception module 3 can receive or detect the entered keyword when the web client 100 is at text non-input status. When predetermined text or keyword is entered by input device (e.g. keyboard), in general, OS of the data processing device where the web client 100 runs receives information corresponding to the entered text or keyword. Then, the OS transfers the entered text or keyword to the web client 100 if the web client 100 is at text input status, the web client 100 displays the entered text or keyword to the text input UI, and the entered text can be used as predetermined variable or parameter value of the text input UI. Otherwise the OS can ignore the entered text or keyword when the data processing device is set as text non-input status.

According to technical idea of present invention, however, the reception module 3 can receive or detect the entered keyword at text non-input status. For example, when information corresponding to entered keyword at text non-input status is outputted to predetermined OS component (e.g. keyboard controller) from input device, and when it is outputted to other OS component (e.g. CPU controller) from the OS, the reception module 3 can receive or detect the information corresponding to entered keyword by hooking the message outputted to the OS component from the input deceive or the message transmitted on the OS, or reading predetermined OS component (e.g. an input parameter recorded at input and output port of keyboard) directly. Many traditional technologies to receive or detect information entered from an input device (e.g. a keyboard) can be applied.

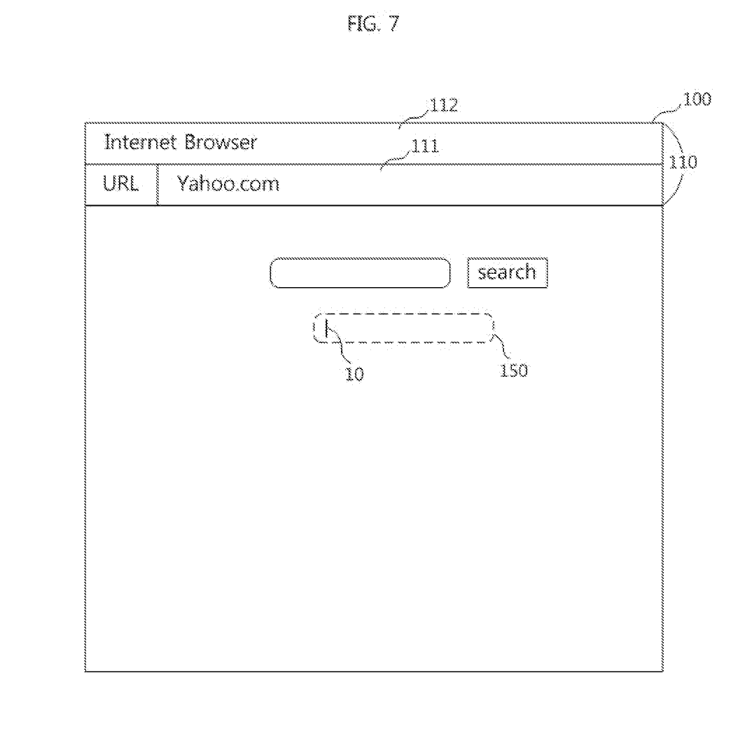

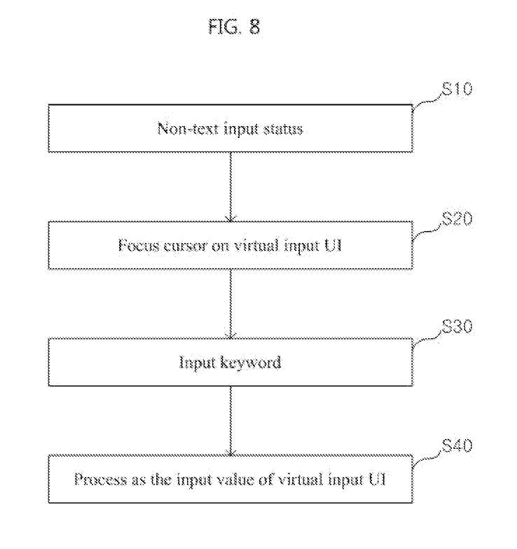

Or the reception module 3 can use predetermined virtual input UI to receive the entered keyword at text non-input status. A concept or method of receiving (detecting) the entered keyword at text non-input status by using the virtual input UI is shown in FIG. 7 and FIG. 8.

FIG. 7 illustrates the concept of processing the keyword entered at text non-input status in providing method for web client according to an embodiment of present invention and FIG. 8 illustrates the flow of processing the keyword entered at text non-input status in providing method for web client according to an embodiment of present invention.

As shown in FIG. 7 and FIG. 8, the system for providing a web client 1 can create predetermined virtual input UI 150 to receive the entered keyword at text non-input status. The virtual input UI 150 is created by the system for providing a web client 1, but it can be realized as a predetermined text input UI (e.g. a text box) that is not displayed, in other words, not seen to users, in the web client 100. The reception module 3 can create the virtual input UI 150, and set a cursor to be placed at the virtual input UI 150 (S20) if the web client 100 is set as text non-input status (S10). For example, if the virtual input UI 150 is created as an object called ‘a.textbox’ and if the web client 100 becomes text non-input status, then the reception module 3 can call predetermined function (e.g. a focus) or predetermined method to place a cursor 10 to the ‘a.textbox’. In such case, the keyword can be the input parameter (S40) of the virtual input UI 150 when predetermined keyword is entered at text non-input status (S30). In other words, the keyword entered at text non-input status is not ignored and it can be processed as the input parameter entered at the virtual input UI 150. In such case, the control module 2 can use the input parameter, in other words, the keyword according to which function the keyword will be used. For instance, when the control module 2 may want to use the keyword as the search term, the control module 2 can simply hand over the value that is entered and saved to the virtual input UI 150 as the input parameter of the search window 131. Or the control module 2 can judge the keyword as the keyword for URL. The keyword for URL can mean the keyword itself can be a URL corresponding to predetermined web page or the keyword is some keyword of predetermined URL. For example, when the keyword is ‘www.abc.com’, the control module 2 can set the keyword as the input parameter of URL input interface 111 and control the web client 100 to browse with the set input parameter. The control module 2 can call predetermined function or method in order to browse by making the keyword as URL, and a web page corresponding to the keyword can be browsed. If the keyword is ‘yahoo’, then the control module 2 can search the URL (e.g. ‘yahoo.com’) corresponding to the keyword in predetermined DB (not shown) that is saved in the system for providing a web client 1, and then the web client 100 may browse a web page corresponding to the searched URL. Of course, the control module 2 can try to browse by making the keyword as URL even when the keyword is not URL address. At this time, information about URL corresponding to the keyword can be saved in DNS (Domain Name Server) or gateway, and the web client 100 can browse predetermined web page based on the information saved in DNS or gateway. The web client 100 can transmit the entered value at the virtual input UI 150 with the input parameter of comment input UI (not shown) included in the web page that the web client 100 is browsing or community board input UI.

In any cases, if the virtual input UI 150 is used, information about the keyword can be saved to the virtual input UI 150, even though behaviors like reading the entered keyword at text non-input status from predetermined OS component or hooking at API (Application Programming Interface) or kernel are not performed, and the keyword can be used easily to perform predetermined function judged by the control module 2.

Meanwhile when FIG. 3 is referred again, the control module 2 can determine the keyword received by the reception module 3 as one purpose among multiple predetermined purposes or using the keyword as predetermined purpose. For instance, the purpose of keyword might be keyword for URL, keyword for comment or board, keyword for email, and/or search term. Cases of using the keyword as the keyword for URL or the search term will be mainly explained in the below for convenience of explanation.

If the keyword is used as the keyword for URL, the web client 100 can perform browsing predetermined URL based on the keyword. If the keyword is used as the search term, the web client 100 ban perform search with the search term.

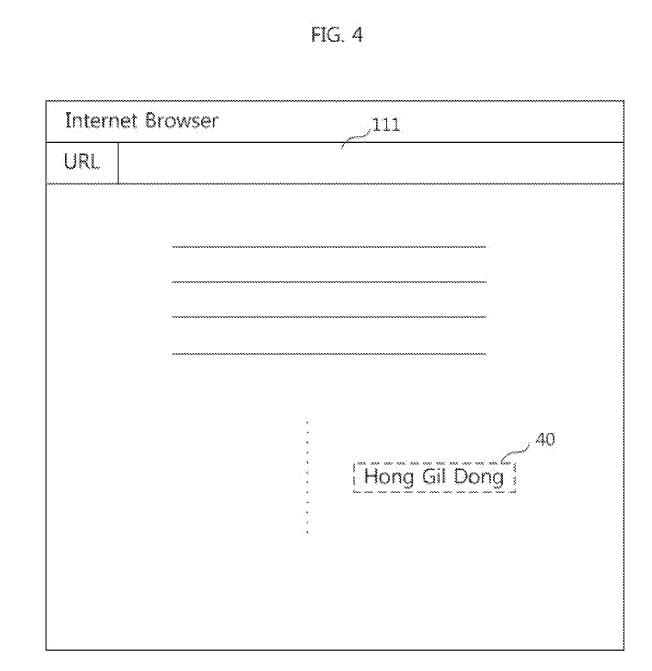

Moreover, the control module 2 can also provide predetermined user confirmation UI (e.g. 40 in FIG. 4) for a user to confirm the keyword that he or she entered at text non-input status. A user can confirm or check the keyword (e.g. Hong Gil Dong) the user is inputting, through the user confirmation UI 40. The user confirmation UI 40 can perform a function of displaying the keyword that a user had entered at text non-input status. The user confirmation UI 40 can be easily embodied by creating the virtual input UI 150, and making the created virtual UI 150 visible, and therefore effects of using the virtual input UI 150 can increase. By providing this user confirmation UI 40, a user can confirm the keyword and accuracy of text the user is inputting at text non-input status, by the user's own eyes.

The control module 2 can control the web client 100 to browse with predetermined URL or to display the search result by making the keyword as the search term using the keyword entered at text non-input status.

In other words, the control module 2 can use the keyword with the input parameter of the first or the second text input UI without performing change action from text non-input status to text input status. So without action for locating a cursor to the text input UI, the control module may make the keyword entered at text non-input status to be used as the input parameter of the first text input UI (namely, a text input UI included in the web client 100 itself) and the second text input (namely, a text input UI included in the web page that is browsed by the web client 100). In general, the types of UIs that can be the first or second text input UIs include the URL interface 111 and the search window 131 shown in FIG. 1. Of course, a comment UI and a bulletin board UI can also included.

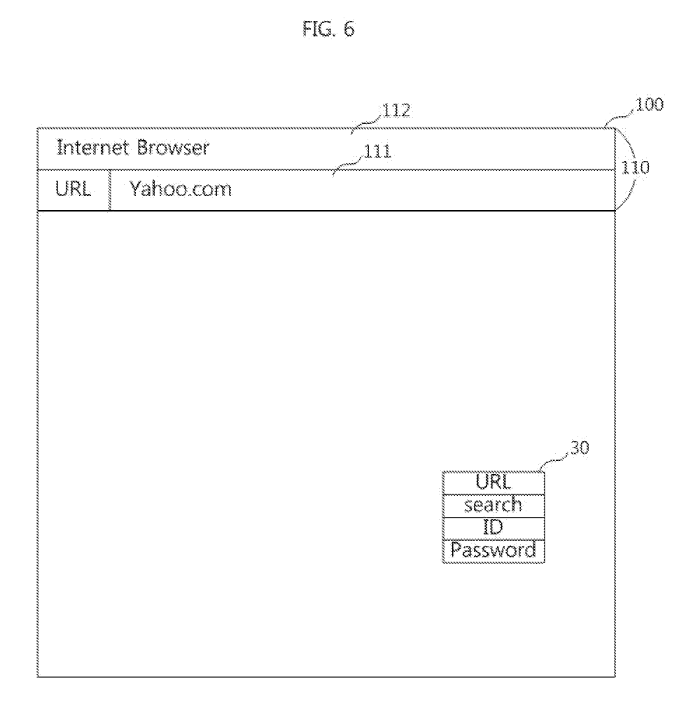

FIG. 6 illustrates a case where the keyword entered at text non-input status is processed as the input parameter of a certain text input UI in method for providing a web client according to an embodiment of present invention.

As shown in FIG. 6, when predetermined keyword is entered at text non-input status, the keyword can be processed as an input parameter of the first text input UI and/or the second text input UI. If the first text input UI and the second text input UI are more than one then a user can select text input UI among the first text input UI and the second text input UI, then the keyword may be used as input parameter of selected text input UI. To that end, the system for providing a web client 1 can provide the list 30 of the first text input UI and the second text input UI on the screen that is currently being displayed. Information about comment or community board UI can be included in the list 30. For instance, when a user selects a comment from the list 30, user may further select a piece of content among a number of pieces of content that are being browsed in the web client 100, then the selected comment may be comment of selected content.

The keyword, of course, can be used as the input parameter of other application (e.g. email client and message transfer client), besides used as the input parameter of the first text input UI and the second text input UI as mentioned earlier. At this time, information about other above application can be included in the list 30, too.

In the example shown in FIG. 6, the first text input UI can be the URL interface 111, and the second input UI can be search window 131, ID and password input UI 132, 133. Therefore, information about four text input UI can be included in the list 30. A user can select predetermined text input UI from the list 30. If then the keyword can be used as the input parameter of the selected text input UI. Being used as the input parameter of the selected text input UI refers that result of function or action is same as the keyword is entered at the text input UI, and it doesn't always mean the keyword is actually entered in the text input UI.

For instance, user can input keyword ‘Hong Gil Dong’ at text non-input status and input predetermined key (e.g. enter). When predetermined key (e.g. enter) is entered, the system for providing a web client 1 knows that inputting of keyword has been completed. In such case, the system for providing a web client 1 can provide the list 30 of the text input UI included in the first text input UI and the second text input UI in order to confirm to what text input UI does the keyword corresponding to. If a user selects the ID input UI 132 from the list 30 then ‘Hong Gil Dong’ keyword can be entered as ID. If a user is selecting the search window 131, then the ‘Hong Gil Dong’ keyword can be the search term. Then, the search term called the ‘Hong Gil Dong’ can be transmitted to the search server, and search results received from the search server can be displayed at the web client 100.

Whether to what use (purpose) of the keyword will be used or to what input parameter of the text input UI it will be used can be determined variously. For example, the keyword can only be used for certain purpose. If a certain keyword is entered at text non-input status then the keyword can be always used as the keyword for URL. In another embodiment of present invention, if a certain keyword is entered at text non-input status then the keyword can always be used as the search term.

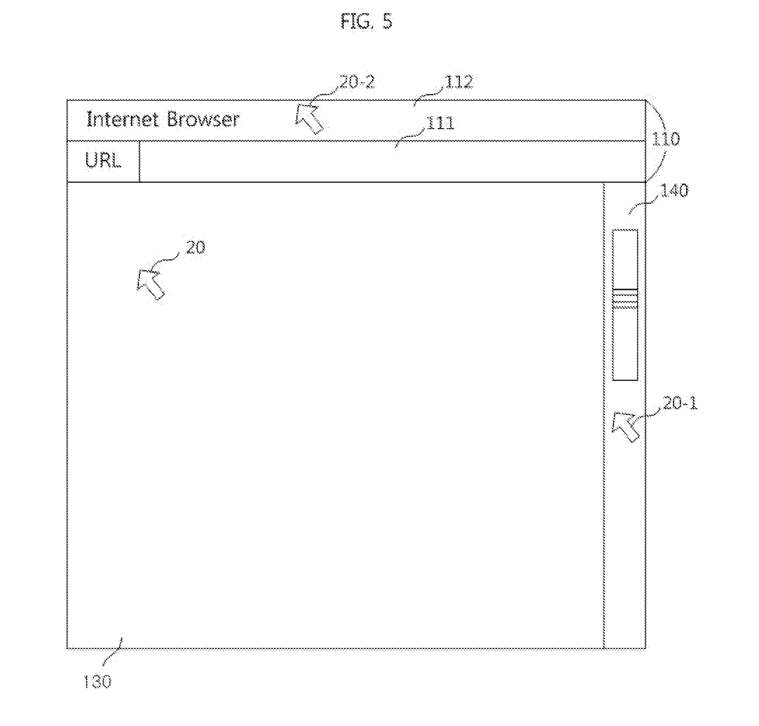

Purpose of the keyword can be determined by choice of user as mentioned earlier, or purpose of the keyword can be determined according to a certain condition. For example, the certain condition can include information of a current pointer status or characteristics of web page that the web client 100 is currently browsing. Information of the current pointer status can include at least one piece of information among the information of last position which pointer had been selected or the current position of pointer. This will be explained in FIG. 5.

FIG. 5 illustrates the use of keyword by pointer status in method for providing a web client according to an embodiment of present invention.

As shown in FIG. 5, the web client 100 can be set as text non-input status by how a user selects (e.g. click) predetermined territory by using a pointer 20, 20-1, and 20-2. For instance, the territory that a user lastly selected using the pointer 20-2 and 20-1 is an interface (e.g. 112, 140) of the web client 100 itself, and then the control module 2 can determine the keyword as a certain purpose (e.g. a keyword for URL) when a keyword is entered at text non-input status.

In addition, the territory that a user lastly selected using pointer 20 is the territory (e.g. 130) that the web client 100 browses predetermined web page, and then the control module 2 can determine the keyword as a certain purpose (e.g. a search term) when a keyword is entered at text non-input status.

The control module 2 also can determine the use of the keyword differently based on the location of current pointer at text non-input status in accordance with example of implementation. According to technical idea of present invention, the purpose (usage) of the keyword can be used differently according to action or behavior made by user while the user uses the web client 100. When the interface (e.g. 112, 140) of the web client 100 itself is selected by pointer, possibility to select browsing to other web page is high. When the web page currently being displayed is the search result page and the search results territory 130 is selected by pointer or if the pointer is currently located, a possibility to perform a new search is high. Therefore, an effect of using the keyword to meet intention of a user can be provided according to status of pointer. The keyword, of course, can only be used for a certain purpose (e.g. a search term) according to example of implementation.

In addition, the control module 2 can determine the purpose of the keyword differently according to characteristics of the web page that is being browsed. Refer to FIG. 4 about this.

FIG. 4 illustrates the use of keyword by the characteristics of web page in method for providing a web client according to an embodiment of present invention.

As shown in FIG. 4 the control module 2 can determine the purpose of the keyword based on characteristics of the page that is being browsed by the web client 100. Characteristics of the page can be vary from whether the page includes text input UI, what text input UI does the page include, or URL of the page. For example, only the first text input UI 111 might exist in the page browsed by the web client 100, and the second text input UI may not exist, in other words, the text input UI included in the page might not exist. In this case, the control module 2 can determine the keyword as a certain purpose (e.g. a keyword for URL). There is high possibility that a keyword which a user using the page inputs at text non-input status might not be the search term because the page does not provide a certain function (e.g. a search service). Therefore, the keyword can be determined for a certain purpose such as keyword for URL, keyword for comment, keyword for sending message, or keyword for email instead of the search term.

For instance, the page can be the default page provided by the web client 100. In such case, the control module 2 can determine the keyword entered at text non-input status from the default page for a certain purpose (e.g. a keyword for URL or search term). Therefore, there is an effect of performing the function without performing browsing to other page in order to perform the function even through there is no predetermined function at a certain web page (e.g. a default page or page with no search function) according to technical idea of the present invention.

In addition, as shown in FIG. 4, the control module 2 can make user to confirm a keyword he or she is inputting by displaying the entered keyword on predetermined user confirmation UI 40 when a user is inputting predetermined keyword at text non-input status.

The control module 2 can use the keyword for predetermined usage when predetermined keyword is entered at text non-input status according to example of implementation. At this time, status of the current pointer or characteristics of the web page might not be considered as mentioned above. For example, the control module 2 can always determine the keyword entered at text non-input status as the search term.

In such case, the control module 2 can transmit the keyword to predetermined search server. The search server can be the search server determined according to the web page that is browsed by the web client 100. In other words, the search server which the search term is transmitted when the search windows is provided to the actual above web page and the search term is entered in the search window and the search server where the control module 2 transmits the keyword might be same. At this time, the control module 2 can set the keyword as the input parameter of the search window.

Meanwhile, the control module 2 can be determined beforehand in addition to the search server set by the web page or the keyword can be directly transmitted to the search server selected by a user. A user can select a search server to perform search by using the keyword entered at text non-input status by using predetermined key (e.g. a hot-key) as the search term.

For instance, a user can search predetermined information in a certain search site. The user can confirm the search result by using scroll or page selection, and might not find the result that he or she wanted. In such case, a user can input a certain keyword at text non-input status. The user might want the search results of the other search server that is different from the search server connected with the search site currently. Therefore, the control module 2 can transmit the keyword to the search server that is determined according to the currently browsing page, other predetermined search server that is not relevant to the currently browsing page, or the search server that is selected by a user. If a user inputs the keyword, the control module 2 can make a user to select the search server by providing predetermined search server list to the user according to an embodiment of present invention. A user can simply select the search server he or she wanted by using predetermined hot key. In such case, the control module 2 can transmit the keyword entered at text non-input status to the search server selected by a user. The search result transmitted from the search server in response to transmitting the keyword, and search result can be displayed at the web client 100.

Meanwhile, the control module 2 can always use the entered keyword at text non-input status as the keyword for URL. In such case, the control module 2 can control the web client 100 to browse the keyword, or control the web client 100 to browse the search URL after searching URL corresponding to the keyword in the saved DB.

After all, above the system for providing a web client 1 according to example of conducting the present invention or the web client 100 where the system for providing a web client 1 is installed can use the keyword for predetermined usage or purpose when the keyword is entered at text non-input status, and it can also use the keyword as other purpose according to a certain condition or choice of a user. A web client that provides technical idea as mentioned can be developed. At this time, the system for providing a web client 1 doesn't have to be separately installed at the web client or at the data processing device where the web client runs. This technical idea can be applied to predetermined data processing device, not just about the web client.

Predetermined application, in other words, the system for providing a data processing device can be installed in the data processing device, in order for the data processing device to use the entered keyword at text non-input status for the predetermined purpose. The application can include a reception module and a control module as the system for providing a web client 1 as mentioned above. The reception module can receive or detect the entered keyword if predetermined keyword is entered by input device when the data processing device is set as text non-input status. The control module can make the keyword to be browsed in predetermined web client by using it as the keyword for URL. It can transmit it to predetermined search server by making the keyword as the search term and load the search result to predetermined web client.

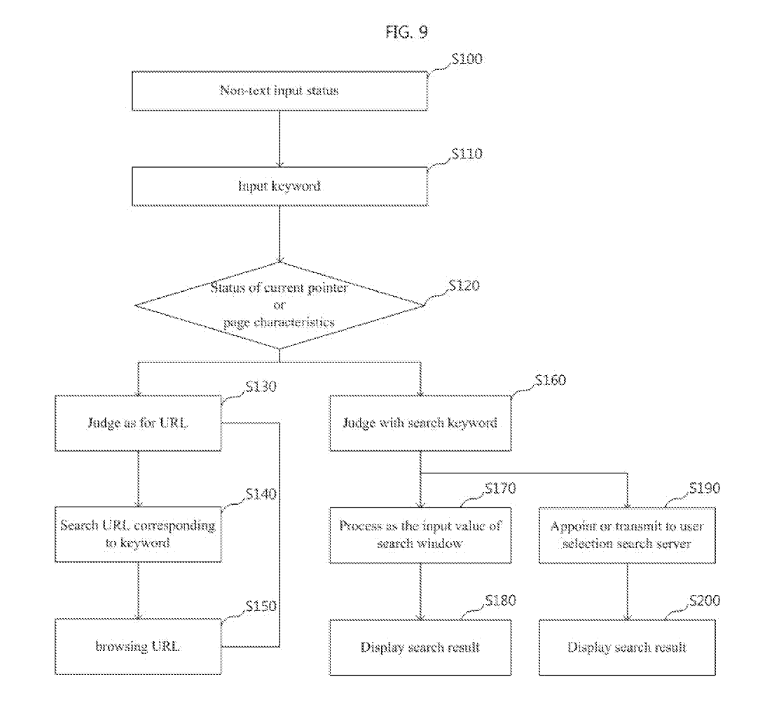

FIG. 9 illustrates the flow for providing a web client or data processing device according to an embodiment of present invention.

As shown in FIG. 9, the web client 100 can be set as text non-input status (S100). If predetermined keyword is entered through input device at text non-input status (S110), the system for providing a web client 1 can determine the usage of the keyword according to the characteristics of the page that is currently being browsed (S120).

If the usage of the keyword is judged as the keyword for URL (S130), then the system for providing a web client 1 can control the web client 100 to browse the keyword, in other words, URL. If the keyword is a keyword of predetermined URL, the system for providing a web client 1 can search the URL that corresponds to the keyword (S140). In such case, the system for providing a web client 1 can control the web client 100 to browse the searched URL.

Meanwhile, when use of the keyword is judged as the search term (S160), the system for providing a web client 1 can receive the search result which is the result corresponding to the keyword as predetermined search term from predetermined search server and display it on the web client 100. To that end, the system for providing a web client 1 can process the search term with the input parameter of search window 131 included in a browsing web page, transmit it to the search server corresponding to the web page (S170), and to display the search result (S180). The keyword can be transmitted to already designated search server or the search server selected by a user according to example of present invention (S190), and the search result can be displayed on the web client 100 (S200).

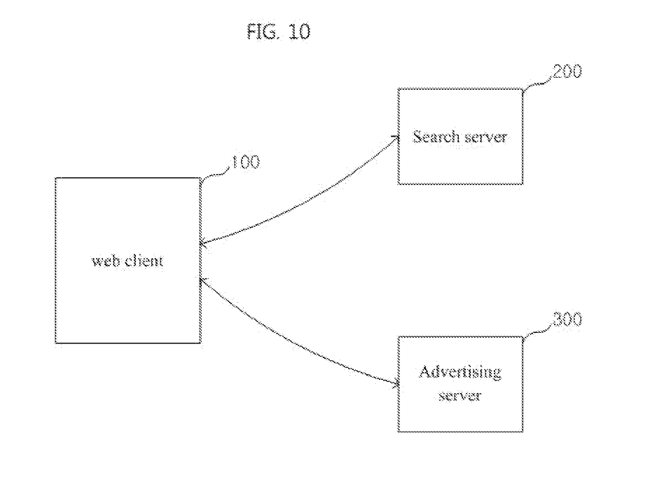

FIG. 10 illustrates an embodiment of the present invention where a keyword is used as search term by web client.

As shown in FIG. 3 and FIG. 10, the web client 100 in the present invention can be linked with a predetermined search server 200 and an advertisement server 300. The system for providing a web client 1 can be installed or connected according to example of present invention at the web client 100.

When predetermined keyword is put into the web client 100 at text non-input status, the web client 100 or the system for providing a web client 1 can transmit the keyword to the search server 200. Moreover, the advertisement module 4 can transmit the keyword to predetermined advertisement server 300. In such case, the web client 100 can display the search result that corresponds to the keyword received from the search server 200. In addition, the advertisement module 4 can display advertisement information corresponding to the keyword received from the advertisement module 4. Therefore, predetermined keyword advertisement can be performed when the keyword is searched at text non-input status.

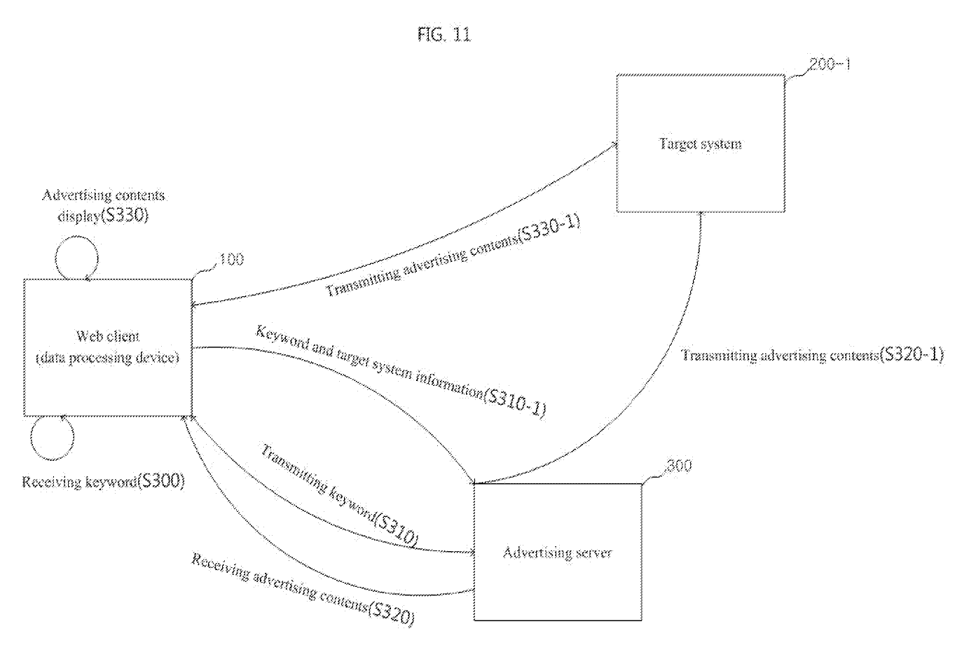

FIG. 11 shows an embodiment of the present invention to explain the keyword advertising method of using the web client or the data processing device.

As shown in the FIG. 11, the web client (or a data processing device) 100 can receive predetermined keyword at text non-input status (S300). In such case, advertisement module 4 included in the web client (or the system for providing data processing device) can transmit the advertising keyword to advertisement server 300 (S310). In addition, the advertisement module 4 can receive advertisement content received from the advertisement server 300 by responding to transmission (S320). This specification will skip detailed explanation since a method that predetermined advertisement content can be selected according to the keyword can be various and a method widely known can be used.

The received advertisement content can be displayed at predetermined territory of the web client (or the data processing device) 100. On the other hand, according to example of present invention, the web client (or the data processing device) 100 can use the keyword for predetermined usage or determine the usage of the keyword, and the advertisement content can be displayed at predetermined territory of screen (UI) displayed at the web client (or the data processing device) 100 when the used result is displayed at the web client (or the data processing device) 100.

For instance, when the keyword is used as search term, the search result that has the keyword as the search term can be displayed at the web client (or the data processing device) 100. In this case, the advertisement content can be displayed at the screen where the search result is displayed or at other predetermined territory as the search result is displayed. When the keyword is used as keyword for URL, then a web page that corresponds to the keyword can be browsed at the web client (or the data processing device) 100. In such case, the advertisement content can be displayed when the web page is browsed or in the screen where the web page is browsed.

Meanwhile, result of using the keyword is not always displayed at the web client (or the data processing device) 100. For example, when the keyword is used as keyword for email or transmitted as keyword for message, the transmission result can be displayed in the web client (or the data processing device) 100. However, the result of using the keyword can be displayed in a phone terminal that receives destination email system where the keyword or message that includes the keyword is used. As such, this specification can define the system where the result of using the keyword is as the destination system 200-1. In such case, the destination system 200-1 can be one of content server (not shown) that provides content corresponding to the comments when the keyword is used as comment, a terminal that receives the message when the keyword is used as message, or an email system that receives the email when the keyword is used as the content of the email.

Therefore, technical idea of present invention is to ensure that the advertisement content can be displayed in the destination system 200-1 as well.

To that end, the web client (or the data processing device) 100 can transmit the received advertisement content to the destination system 200-1 (S330-1) when the advertisement content are received from the advertisement server 300 (S320), and then the advertisement content may be displayed at the destination system 200-1. For instance, if the keyword is for email, then the web client (or the data processing device) 100 can transmit the email to the destination system 200-1 after making the advertisement content received from the advertising server 300 to be included in the e-mail content or to be displayed at predetermined domain. If the keyword is one for sending message, then the web client (or the data processing device) 100 make the advertisement content included in the message content, or push the advertisement content as transmitting the message to the destination system 200-1.

Meanwhile, other example of implementation that can transmit advertisement content to the destination system 200-1 is not transmitting the received advertisement content after the web client (or the data processing device) 100 receives the advertisement content from the advertisement server 300, and it can make the advertisement server 300 to transmit the advertisement content to the destination system 200-1.

To that end, the web client (or the data processing device) 100 can understand information about the destination system 200-1 according to use of received keyword if the keyword is received from the user (S300). For example, email address, receptor's phone number, URL of server that provides comments or board can be information about the destination system 200-1. In such case, the web client (or the data processing device) 100 can transmit information about the destination system 200-1 to the advertisement server 300 as transmitting the keyword to the advertisement server 300 (S310-1). Then, the advertisement server 300 can select advertisement content based on the keyword and transmit the selected advertisement content to the destination system 320-1. Or the web client (or the data processing device) 100 can transmit information about the advertisement server 300 (e.g. URL) to the destination system 200-1 more as transmitting the keyword to the destination system 200-1. For instance, when the keyword is used for email, the web client (or the data processing device) 100 can include predetermined code that the advertisement server 300 can transmit the advertisement content to the destination system 200-1 and transmit to email. In such case, the code can request and receive the advertisement content from the advertisement server 300 by referring to information about the advertisement server 300. According to example of implementation, the web client (or the data processing device) 100 can transmit information about the destination system 2001 more as transmitting email that includes the keyword to the advertisement server 300. In such case, the advertisement server 300 can receive the email and transmit the received email and the advertisement content to the destination system 200-1. Normal expert in the technical field of the present invention can easily infer that advertisement content can be transmitted to the destination system 200-1 by the advertisement server 300 when the keyword is used for other usage.

The web client, the system for providing a web client, the data processing device, and the system and method for providing a data processing device according to embodiments of present invention can be implemented with codes that are recorded in record media and can be read by computer. Record media that a computer can read includes all kinds of recording device where computer-readable data are saved. Computer-readable record devices include ROM, RAM, CD-ROM, magnetic tape, hard disk, floppy disk, optical data processing device and media that can be read in carrier wave format like transfer through internet. In addition, record media that can be read by computer can be spread into the computer system connected as network and a code that a computer can read with dispersion method can be saved and performed. And functional program, code, and code segments to realize the present invention can be easily inferred by programmers of technical field that the present invention belongs.

The present invention was explained through the implementation example shown in drawings, but that only reflects an example, and any professional with common knowledge in this technical field will be able to apply this intention more diversely. Therefore, the scope for the protection of the technical value of this intention will need be determined by the attached technical specification.

1. A method for providing a web client, comprising:
setting the web client to a text non-input status; and
when a keyword is input to a data processing device, which operates the web client, by an input device in the text non-input status, using, by a system for providing a web client, the keyword for a predetermined purpose or determining a purpose of the keyword from among a plurality of purposes.

2. The method of claim 1, wherein using the keyword for a predetermined purpose or determining the purpose of the keyword from among a plurality of purposes comprises variously determining the purpose of the keyword according to at least one of a current pointer status of a pointing device, which controls the data processing device, and a characteristic of a web page that the web client is currently browsing.

3. The method of claim 1, wherein using the keyword for a predetermined purpose or determining the purpose of the keyword from among a plurality of purposes comprises:
providing, by the system for providing a web client, a list of the plurality of purposes; and
determining the purpose of the keyword as one selected from the list by an input device, the input device connected to the data processing device.

4. The method of claim 1, wherein each of the purposes corresponds to a respective one of a plurality of text input user interfaces included in the web client.

5. The method of claim 1, wherein the non-input status is one selected from the group consisting of:
a status in which a cursor is located neither in a first text input user interface provided by the web client nor in a second text input user interface included in a page displayed by the web client,
a status in which neither the first text input user interface nor the second text input user interface exist, and
a status in which the cursor is not located in the first input user interface and the second text input user interface does not exist.

6. The method of claim 2, wherein the current pointer status includes at least one selected from the group consisting of information about a location of a most recent click of a pointer and information about a current location of the pointer.

7. The method of claim 1, wherein the purpose of the keyword includes at least one selected from the group consisting of a uniform resource locator, a search term, a content of a comment, a content of an email, and a content of a message.

8. The method of claim 7, further comprising browsing, by the web client, a uniform resource locator corresponding to the keyword.

9. The method of claim 7, further comprising controlling, by the system for providing a web client, the web client to input the keyword as a comment to the content included in the web client.

10. The method of claim 7, further comprising at least one of:
transmitting the message including the keyword to a predetermined phone number or to a phone number selected by the input device connected to the data processing device; and
transmitting an email including the keyword to the predetermined email address or to an email address selected by the input device connected to the data processing device.

11. The method of claim 8, further comprising determining that the uniform resource locator corresponds to the keyword.

12. The method of claim 6, wherein the web client displays a search result corresponding to the keyword.

13. The method of claim 12, further comprising:
transmitting, by the web client or the system for providing a web client, the keyword to a predetermined search server; and
receiving the search result from the search server, the search result searched by the search server based on the transmitted keyword.

14. The method of claim 13, wherein transmitting the keyword comprises processing the keyword as an input parameter of a search window included in a web page.

15. The method of claim 1, further comprising detecting, by the system for providing a web client, the keyword input to the data processing device from the input device.

16. The method of claim 1, further comprising controlling, by the system for providing a web client, the keyword to be displayed via a predetermined user confirmation user interface.

17. The method for claim 15, wherein detecting the keyword comprises:
placing a cursor in a virtual input user interface, which is created by the system for providing a web client, when the web client is set to the text non-input status; and
processing the keyword as an input parameter of the virtual input user interface.

18. The method of claim 1, wherein the system for providing a web client is embodied by a script included in the web client, an add-on or plug-in program installed in the web client, or a predetermined application installed in the data processing device, which operates the web client.

19. A method for providing a web client, comprising:
setting the web client to a text non-input status;
inputting, by an input device, a keyword to a data processing device, which operates the web client, in the text non-input status; and
displaying, by the web client, a search result obtained using the keyword as a search term.

20. A method for providing a web client, comprising:
setting the web client to a text non-input status;
inputting, by an input device, a keyword to a data processing device, which operates the web client, in the text non-input status; and
browsing, by the web client, a uniform resource locator corresponding to the keyword.

21. A method for providing a web client, comprising:
setting the web client to a text non-input status; and
when a keyword is input to a data processing device, which operates the web client, by an input device in the text non-input status, transmitting, by a system for providing a web client, the keyword to an advertising server and receiving an advertising content from the advertising server in response to the transmitted keyword.

22. The method of claim 21, further comprising using, by the system for providing a web client, the keyword for a predetermined purpose or determining a purpose of the keyword from among a plurality of purposes.

23. The method of claim 21, further comprising, when the keyword is used according to the determined purpose, transmitting the advertising content to a target system corresponding to a result of use of the keyword.

24. The method of claim 23, wherein the target system includes at least one selected from the group consisting of the data processing device, which operates the web client, a content server, which provides a content corresponding to a comment when the keyword is used as the comment, a terminal, which receives a message when the keyword is used as the message, or an email system, which receives an email when the keyword is used as a content of the email.

25. A method for providing a web client, comprising:
setting the web client to a text non-input status; and
when a keyword is input to a data processing device, which operates the web client, by an input device in the text non-input status, using, by a system for providing a web client, the keyword for a predetermined purpose or determining a purpose of the keyword from among a plurality of purposes; and
when the keyword is used according to the determined purpose, controlling, by the system for providing a web client, an advertising server to transmit an advertising content to a target system corresponding to a result of use of the keyword;
wherein the advertising content is selected by the advertising server based on the keyword.

26. A method for providing a data processing device, comprising:
setting the data processing device to a text non-input status; and
inputting, by an input device, a keyword to a data processing device in the text non-input status; and
using, by a system for providing a data processing device, the keyword for a predetermined purpose or determining a purpose of the keyword from among a plurality of purposes, wherein the system for providing a web client is operated in the data processing device.

27. A method for providing a data processing device, comprising:
setting the data processing device to a text non-input status; and
when a keyword is input to the data processing device by an input device in the text non-input status, transmitting, by a system for providing a data processing device, the keyword to an advertising server and receiving an advertising content from the advertising server in response to the transmitted keyword.

28. A method for providing a data processing device, comprising:
setting the data processing device to a text non-input status;
when a keyword is input to the data processing device by an input device in the text non-input status, using, by a system for providing a data processing device, the keyword for a predetermined purpose or determining a purpose of the keyword from among a plurality of purposes, wherein the system for providing a web client is operated in the data processing device;
controlling an advertising server to transmit an advertising content to a target system corresponding to use results when the keyword is used according to the determined purpose; and
when the keyword is used according to the keyword and the determined purpose, controlling, by the system for providing a web client, the advertising server to transmit an advertising content to a target system corresponding to a result of the use of the keyword;
wherein the advertising content is selected by the advertising server based on the keyword.

29. A system for providing a web client linked to a web client that can browse a web page, the system using, when a keyword is input to a data processing device, which operates the web client, by an input device in a state in which the web client is set to a text non-input status, the keyword for a predetermined purpose or determining a purpose of the keyword from among a plurality of purposes.

30. The system of claim 29, comprising:
a reception module for receiving the keyword input in the text non-input status; and
a control module for determining the keyword to be used for a predetermined purpose or the purpose of the keyword from among a plurality of purposes.

31. The system of claim 30, wherein the control module variously determines the purpose of the keyword according to at least one of a current pointer status of a pointing device, which controls the data processing device, and a characteristic of a web page that the web client is currently browsing.

32. The system of claim 29, wherein the purpose of the keyword includes at least one selected from the group consisting of a uniform resource locator, a search term, a content of a comment, a content of an email, and a content of a message.

33. The system of claim 30, wherein the control module uses the keyword as an input parameter of a text input user interface included in the web page.

34. The system of claim 30, wherein the control module uses the keyword as an input parameter of a uniform resource locator input user interface included in the web page, or searches a uniform resource locator corresponding to the keyword from a predetermined database and processes the searched uniform resource locator as the input parameter of the uniform resource locator input user interface.

35. The system of claim 30, wherein the reception module places a cursor in a virtual input user interface when the web client is set to the text non-input status to receive the keyword from the above input device, and processes the keyword as an input parameter of the virtual input user interface.

36. A system for providing a web client linked to a web client, which browses a web page, the system controlling, when a keyword is input to a data processing device, which operates the web client, by an input device in a state in which the web client is set to a text non-input status, the web client to display a search result obtained using the keyword as a search term.

37. A system for providing a web client linked to a web client, which browses a web page, the system controlling, when a keyword is input to a data processing device, which operates the web client, by an input device in a state in which the web client is set to a text non-input status, the web client to browse a uniform resource locator corresponding to the keyword.

38. A web client, which browses a web page, the web client displaying a search result obtained using a keyword as a search term when the keyword is input to a data processing device, which operates the web client, by an input device in a state in which the web client is set to a text non-input status

39. A web client, which browses a web page, the web client browsing a uniform resource locator corresponding to a keyword when the keyword is input to a data processing device, which operates the web client, by an input device in a state in which the web client is set to a text non-input status.

40. A system for providing a data processing device, comprising:
a reception module for receiving a keyword input by an input device in a state in which the data processing device is to as a text non-input status; and
a control module for determining the keyword to be used for a predetermined purpose or a purpose of the keyword from among a plurality of purposes.

41. A system for providing a web client, comprising:
a reception module for receiving a keyword input by an input device in a state in which the web client is to as a text non-input status; and
an advertising module for transmitting the keyword, which is received by the reception module, to advertising server and receiving an advertising content from the advertising server in response to the transmitted keyword.

42. The system of claim 41, further comprising a control module for determining the keyword to be used for a predetermined purpose or the purpose of the keyword from among a plurality of purposes.

43. The system of claim 42, wherein the advertising module transmits the advertising content to a target system corresponding to a result of use of the keyword when the keyword is used according to the determined purpose.

44. The system of claim 43, wherein the target system includes at least one of:
a data processing device in which the web client is installed,
a content server for providing a content corresponding to a comment when the keyword is used as the comment,
a terminal for receiving a message when the keyword is used as a content of the message, and
an email for receiving an email when the keyword is used as a content of the email.

45. A system for providing a web client, comprising:
a reception module for receiving a keyword when the keyword is input to a data processing device, which operates the web client, by an input device in a state in which the web client is set to a text non-input status;
a control module for determining the keyword to be used for a predetermined purpose or the purpose of the keyword from among a plurality of purposes; and
an advertising module for controlling an advertising server to transmit an advertising content to a target system corresponding to a result of use when the keyword is used according to the determined purpose,
wherein the advertising content is selected by the advertising server based on the keyword.

46. A system for providing a data processing device, comprising:
a reception module for receiving a keyword input by an input device in a state in which the data processing device is to as a text non-input status; and
an advertising module for transmitting the keyword, which is received by the reception module, to advertising server and receiving an advertising content from the advertising server in response to the transmitted keyword.

47. A system for providing a data processing device, the system comprising:
a reception module for receiving a keyword when the keyword is input by an input device in a state in which the data processing device is set to a text non-input status;
a control module for determining the keyword to be used for a predetermined purpose or the purpose of the keyword from among a plurality of purposes; and
an advertising module for controlling an advertising server to transmit an advertising content to a target system corresponding to a result of use when the keyword is used according to the determined purpose,
wherein the advertising content is selected by the advertising server based on the keyword.

48. A recording medium having embodied thereon a program for the method of claim 1.
